(19) United States
(12) Patent Application Publication
(10) Pub. No.: US 2026/0044031 A1
(43) Pub. Date: Feb. 12, 2026

(54) Opto-Electronic Chiplets for Scalable Coherent Interconnects to Zero-Change VLSI Electronics

(71) Applicant: Massachusetts Institute of Technology, Cambridge, MA (US)

(72) Inventors: Dirk Robert ENGLUND, Brookline, MA (US); Christopher Louis Panuski, Somerville, MA (US); Hugo Larocque, Cambridge, MA (US)

(21) Appl. No.: 18/798,428

(22) Filed: Aug. 8, 2024

(51) Int. Cl. G02F 1/035; G02F 1/03

(52) U.S. Cl. CPC G02F 1/0356; G02F 1/0327; G02F 2203/15; G02F 2203/70

(57) ABSTRACT

Optical chiplets can be mounted to zero-change VLSI chips to form an integrated electro-optical device. Control signals for controlling active optical devices on the optical chiplets can be provided from the VLSI chip and coupled to the active optical devices on the optical chiplets. The technology provides small-area, low-energy, RF optical interfaces for VLSI chips.

### GOVERNMENT SUPPORT STATEMENT

This invention was made with government support under FA8750-20-2-1007 awarded by the Air Force Research Laboratory and under FA9550-20-1-0105 awarded by the Air Force Office of Scientific Research. The government has certain rights in the invention.

### BACKGROUND

Integrating microelectronic devices with microphotonic devices is an area of active interest for a variety of applications including, but not limited to, integrated optical sensors, bioanalysis chips, spatial light modulators, telecommunication transceivers, and quantum computing chips. There have been at least three distinct approaches to integrating microelectronics and microphotonics. One approach is to use materials and microfabrication processes for photonic devices that are compatible with conventional CMOS fabrication steps so that CMOS techniques can be used without introducing new foundry processing techniques. In this approach, the microphotonic devices can be fabricated on chip with conventional electronic integrated circuit (IC) devices using existing CMOS process steps. Such an approach that does not require a non-conventional CMOS process (such as depositing or etching materials not previously used in a CMOS fabrication facility) may be referred to as a zero-change CMOS process. This approach is used in the field of silicon microphotonics. Although this approach benefits from decades of silicon microfabrication development, a limitation of silicon microphotonics is the constraint on materials and process steps permitted for use in the CMOS foundry.

A second approach that has recently emerged is to couple microelectronic chiplets to photonic integrated circuits (PICs), as is currently being pursued by Lightmatter®, Inc. of Mountainview, California. In this approach, an IC chiplet is flip-chip-bonded onto a photonic substrate that provides the optical components. A drawback of this approach is that the photonic substrates can be large to accommodate long waveguides used in photonic devices and optical interconnects on the photonic substrate.

A third approach involves free-space optical links by hybrid integration of gain-modulated light sources. For example, transfer-printed blue micro-LEDs onto a chip can be used as a modulated light source to establish a free-space link with a remote device. However, this approach is limited in reach due to the short wavelength and need for free-space alignment.

### SUMMARY

The present disclosure relates to integrated electro-optical (EO) devices that comprise optical chiplets integrated onto zero-change VLSI electronic chips. In an example implementation, an optical chiplet can comprise at least one microfabricated active optical device (e.g., an integrated optical modulator) that performs a predetermined optical function (e.g., modulate, focus, couple, steer, filter, etc.) on an optical wave that is incident on at least a portion of the optical chiplet. In some implementations, the optical function performed is controllable by at least one control signal. The optical chiplet can be mounted adjacent to a microelectronic interconnection formed on the VLSI chip. The VLSI chip can provide the control signal to the microelectronic interconnection so that the control signal couples to the optical chiplet and controls operation of the at least one active optical device. The VLSI chips can be fabricated using conventional processing techniques such as those used in CMOS foundries. The optical chiplets can be fabricated elsewhere (e.g., using specialized processing steps). The technology provides small-area, low-energy, RF optical interfaces and functionalities for VLSI chips.

Some implementations relate to integrated electro-optical devices comprising: a very large scale integrated (VLSI) chip comprising a semiconductor substrate and a plurality of integrated circuit (IC) devices, the VLSI chip further comprising a microelectronic interconnection formed on a first side of the VLSI chip; and an optical chiplet comprising an active optical device. The optical chiplet can be mounted to the VLSI chip such that the active optical device is adjacent to the first side of the VLSI chip. Further, a control signal can be provided from the VLSI chip to the microelectronic interconnection, when the integrated electro-optical device is operating, and can couple to the active optical device to control the active optical device on the optical chiplet.

Some implementations relate to methods of controlling an active optical device that is formed in an integrated electro-optical device. The integrated electro-optical device comprises a very large scale integrated (VLSI) chip comprising a semiconductor substrate and a plurality of integrated circuit (IC) devices. The VLSI chip can further comprise a microelectronic interconnection formed on a first side of the VLSI chip. The integrated electro-optical device can further comprise an optical chiplet comprising the active optical device, wherein the optical chiplet is mounted to the VLSI chip such that the active optical device is adjacent to the first side of the VLSI chip. The method can comprise and act of providing a control signal from the VLSI chip to the microelectronic interconnection such that the control signal couples to and controls the active optical device on the optical chiplet.

Some implementations relate to methods of making an integrated electro-optical device. Such methods can comprise acts of: aligning an active optical device, formed on an optical chiplet, with a microelectronic interconnection formed on a first side of a VLSI chip, the VLSI chip comprising a semiconductor substrate and a plurality of IC devices; and mounting the optical chiplet to the first side of the VLSI chip such that: the active optical device is adjacent to the microelectronic interconnection; and a control signal provided from the VLSI chip to the microelectronic interconnection, when the integrated electro-optical device is operating, couples to the active optical device and controls the active optical device on the optical chiplet.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A depicts an example of an integrated EO device that comprises a micro-disk resonator formed on an optical chiplet.

FIG. 1B depicts an example of an integrated EO device that comprises a semiconductor optical amplifier formed on an optical chiplet.

FIG. 2A depicts an example of an integrated EO device comprising an array of optical chiplets mounted on a VLSI chip.

FIG. 2B depicts an example of an integrated EO device comprising an array of optical chiplets mounted on a VLSI chip, where the integrated EO device is flip-chip mounted on a printed circuit board.

FIG. 3A depicts an example of an integrated EO device comprising a plurality of different optical chiplets mounted on a VLSI chip.

FIG. 3B depicts further details of an optical chiplet coupled to a semiconductor optical amplifier, both of which could be mounted on the VLSI chip of FIG. 3A.

FIG. 4 illustrates an electric field produced and controlled via electrodes of a microelectronic interconnection on a VLSI chip. The electric field impinges on an active optical device formed on an optical chiplet to modulate an optical field coupled into the active optical device.

FIG. 5A depicts an example of an active optical device comprising a ring resonator or disk resonator that can be fabricated on an optical chiplet.

FIG. 5B depicts another example of an active optical device comprising a disk resonator that can be fabricated on an optical chiplet.

FIG. 6A depicts another example of an active optical device comprising a 1-D photonic crystal (PhC) cavity that can be fabricated on an optical chiplet.

FIG. 6B depicts another example of an active optical device comprising a 2-D PhC cavity that can be fabricated on an optical chiplet.

FIG. 6C depicts another example of an active optical device comprising a distributed Bragg reflector that can be fabricated on an optical chiplet.

FIG. 7A depicts an example of an active optical device comprising a micro-disk resonator that can be fabricated on an optical chiplet and coupled to a CMOS mm-wave source located on a VLSI chip.

FIG. 7B depicts another example of an active optical device comprising a micro-disk resonator that can be fabricated on an optical chiplet and coupled via phonons to a CMOS mm-wave source located on a VLSI chip.

FIG. 7C depicts another example of an active optical device comprising a micro-disk resonator that can be fabricated on an optical chiplet and coupled to a dielectric oscillator and a CMOS mm-wave source located on a VLSI chip.

FIG. 7D depicts an example of an active optical device comprising a 1-D PhC cavity containing a nonlinear optical medium that can be fabricated on an optical chiplet and further can be coupled to a CMOS mm-wave source located on a VLSI chip. The simulation results show the optical field intensity within the 1-D PhC cavity.

FIG. 7E depicts the active optical device of FIG. 7D and an optical field intensity for a second harmonic wave that can be generated by the optical device from an optical wave at a fundamental frequency coupled in the PhC cavity.

FIG. 7F depicts another example of an active optical device comprising a micro-ring resonator for second-harmonic generation that can be fabricated on an optical chiplet and further can be coupled to a CMOS mm-wave source located on a VLSI chip.

FIG. 8 depicts an integrated EO device that can be used for photodetection.

FIG. 9 depicts an active optical device that can be fabricated on an optical chiplet and used for RF signal detection. The device can employ difference-frequency generation to convert a received optical signal encoding information into an RF signal containing the information.

FIG. 10A depicts an active optical device comprising an array of reflective pixels that can be fabricated on an optical chiplet. The reflectivity of each pixel can be controlled with signals provided from the VLSI chip on which the optical chiplet is mounted.

FIG. 10B depicts an example of an optical chiplet comprising a thin-film 2-D PhC cavity.

FIG. 10C depicts a silicon membrane containing about one million optical chiplets, each having the 2-D PhC cavity of FIG. 10B.

FIG. 11A depicts a step of picking up an optical chiplet from an array of optical chiplets fabricated on a substrate.

FIG. 11B depicts placement of the optical chiplet of FIG. 11A into a socket formed on a VLSI chip.

FIG. 11C depicts several steps in a pick-and-place process that can be used to mount optical chiplets on VLSI chips.

FIG. 12 shows a portion of an optical chiplet that has been placed in a socket formed on a substrate and an enlarged view of a portion of the active optical device.

FIG. 13A depicts one approach for coupling an optical fiber to an integrated EO device.

FIG. 13B depicts another approach for coupling an optical fiber to an integrated EO device. In this approach, an optical chiplet is mounted on the end of the optical fiber before mounting the optical fiber to the VLSI chip.

FIG. 14 depicts capacitive microelectronic interconnections and a stack of layers that can be implemented in an integrated EO device.

FIG. 15 depicts areas of an electro-optic material and an electrode that can be involved in coupling signals between an optical chiplet and a VLSI chip.

### DETAILED DESCRIPTION

### 1. Introduction

The inventors have recognized and appreciated that integration of photonic modulators with VLSI electronics in a scalable way without significantly sacrificing performance is challenging. To improve the speed of such integrated devices, lengths of electrical interconnects (which typically limit signaling speed) from any location on a VLSI IC chip to the optical receiver and/or optical transmitter should be reduced. The inventors have realized that one way to reduce electrical interconnect lengths when interfacing with active optical devices is to distribute the active optical device across the area of the VLSI chip, such that the active optical device is close to its electrical driver circuitry. Such distribution of optical devices can be done in a scalable way by forming optical chiplets that contain the desired active and/or passive optical device(s) (e.g., a micro-disk resonator, an optical modulator, a microlens, a tunable optical filter, etc.) and mounting the optical chiplets to the VLSI chip at desired locations (e.g., close to drive circuitry and/or electrical circuitry that interfaces with at least one optical component on the optical chiplet).

The optical chiplets can be integrated onto zero-change, foundry-fabricated VLSI IC chips using pick-and-place technology, for example. This integration of EO devices can greatly simplify fabrication and packaging of the resulting devices. Some interface optical components, such as input/output optical gratings and optical filters, can be co-fabricated with the VLSI electronics process (e.g., fabricated on the same VLSI wafer using conventional CMOS processes while fabricating electronic components on the wafers). Capacitive, inductive, and ohmic electrical connections can be made between the optical chiplets and the VLSI chip. In some implementations, optical transceivers can be formed in membranes of thin-film lithium niobate (TFLN), thin-film barium titanate (TFBTO), silicon membranes formed from silicon-on-insulator (SOI) wafers, and thin-film semiconductors (TFSCs) such as AlGaAs or InP membranes. The optical transceiver can be mounted on a VLSI chip adjacent to drive electronics to obtain high-speed signaling. Bringing the optical modulators closer to VLSI electronics enhances efficiency, reduces latency, lowers energy consumption, and increases modulation bandwidth. This integration also shrinks the footprint of EO devices, enables high-speed data transmission, and can meet the demands of modern networks and computing architectures. The inventors have recognized and appreciated that PIC components having long access waveguides are no longer needed when using optical chiplets, thereby reducing the size of the optical circuits.

A wide variety of optical functionality and applications are possible. An optical chiplet can comprise nanophotonic resonators that provide electro-optic or magneto-optic modulation (modulation of optical phase and/or amplitude). Photodiodes can be formed on the optical chiplet or VLSI chip for photodetection and local sensing. In some cases, an optical chiplet can comprise a semiconductor optical amplifier for optical amplification of signals. The optical chiplets can provide RF interfaces to the VLSI circuitry for applications ranging from high-bandwidth optical communications to phased array lidar and multi-pixel sensors. In some cases, communication to and from an integrated EO device can be made by free-space optical links or fiber links.

### 2. Examples of Integrated Electro-Optical Devices

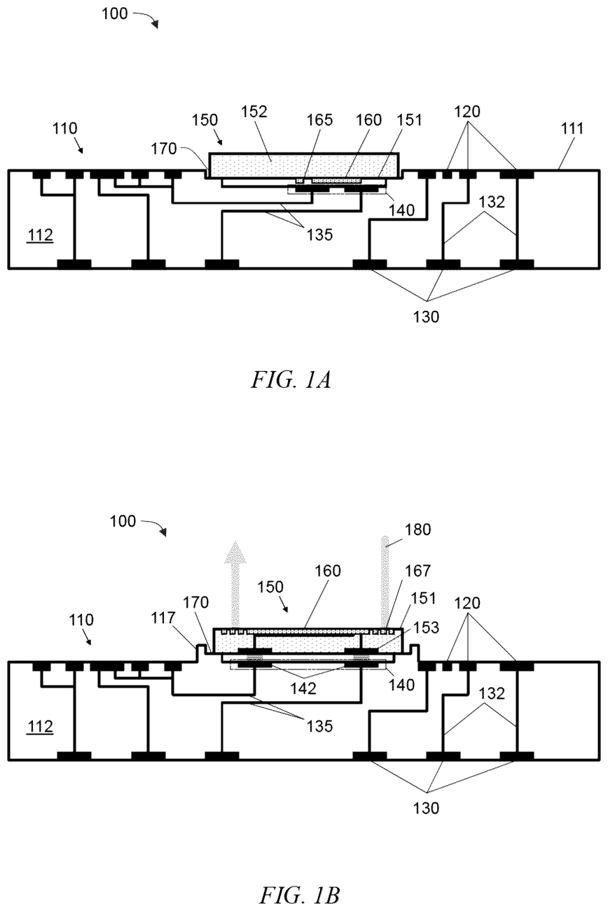

FIG. 1A depicts one example of an integrated EO device 100 that comprises an optical chiplet 150 mounted to a VLSI chip 110. In this implementation, the optical chiplet 150 is flip-chip mounted into a socket 170 formed on the VLSI chip 110. When flip-chip mounted, the process surface 151 of the optical chiplet 150 on which optical devices are formed faces a receiving surface 111 of the VLSI chip 110 on which integrated semiconductor devices 120 may or may not be formed.

FIG. 1B depicts another example of an integrated EO device 100 that comprises an optical chiplet 150 mounted to a VLSI chip 110. In this implementation, the optical chiplet 150 is not flip-chip mounted to the socket 170. Instead, the active optical device 160 on the optical chiplet 150 is formed on a process surface 151 of the optical chiplet 150 that faces away from the receiving surface 111 of the VLSI chip 110.

The optical chiplet 150 comprises a substrate 152 and at least one active optical device 160 and/or at least one passive optical component formed in or on the substrate 152. An active optical device is a device that can be controlled by at least one control signal to perform some optical function (e.g., emit light, amplify light, modulate the phase and/or amplitude of light, adjustably filter optical frequencies, convert light to a different wavelength using a nonlinear optical process such as three-wave mixing, second-harmonic generation, difference-frequency generation, or parametric amplification). A passive optical component can include, but is not limited to, a lens, grating, waveguide, or passive spectral filter. The optical chiplet 110 may or may not further comprise electrical circuitry (e.g., electrical contacts, conductive vias and interconnects, IC devices such as diodes and transistors, etc.).

In the example of FIG. 1A, the active optical device 160 on the optical chiplet 150 can comprise a nanophotonic resonator (e.g., a micro-disk optical resonator, micro-ring resonator, or racetrack resonator) which is coupled to a bus waveguide 165 (which is an example of a passive optical component). The nanophotonic resonator can comprise an electro-optic or magneto-optic material. In the example of FIG. 1B, the active optical device 160 can be a semiconductor optical amplifier (SOA), for example, though other devices including nanophotonic resonators could be implemented in this configuration. Coupling of an optical beam 180 into and out of the SOA can be done with grating couplers 167 (another example of a passive optical component).

The VLSI chip 110 comprises a substrate 112 (typically a semiconductor material such as silicon) on and/or in which are formed a plurality of semiconductor devices 120. The plurality of semiconductor devices 120 can include transistors, diodes, and other integrated circuit components fabricated on VLSI chips. There can be a plurality of conductive interconnects 135 of one or more metal levels, conductive vias 132, and electrical contacts 130 formed in and/or on the substrate 112. Some of the contacts 130 can be used for solder connections (e.g., bump bonding) to a substrate of a package or to a PCB on which other VLSI chips can be mounted.

The VLSI chip 110 can further comprise a microelectronic interconnection 140 for at least coupling control signals to the optical chiplet 150. The microelectronic interconnection 140 can comprise signal-coupling components. Examples of signal-coupling components include, but are not limited to, electrodes for creating an electric field in the vicinity of the microelectronic interconnection 140, conductive contact pads for making an electrical connection to mating contact pads on the optical chiplet 150, capacitive pads for coupling signals capacitively to the optical chiplet 150, and inductive coils for creating a magnetic field in the vicinity of the microelectronic interconnection 140 and/or for coupling signals inductively to mating inductive coils on the optical chiplet 150. In the example of FIG. 1A, the microelectronic interconnection 140 comprises two electrodes to create an electric field that impinges on the active optical device 160. The generated electric field can control the operation of the active optical device. In the example of FIG. 1B, the microelectronic interconnection 140 comprises conductive contact pads 142 for making bump-bond solder connections to mating contact pads 153 on the optical chiplet 150. Electrical current can then be driven through an active optical device 160 on the optical chiplet 150 to control operation of the active optical device.

The socket 170 can comprise a receiving structural feature formed on the receiving surface 111 of the VLSI chip 110. The receiving structural feature can comprise at least one depression etched into the VLSI chip 110, as depicted in FIG. 1A. In some cases, the receiving structural feature can comprise one or more raised features 117 (ridges, posts, pins, etc.) formed on the receiving surface 111 of the VLSI chip 110, as depicted in FIG. 1B. In some implementations, the receiving structural feature can comprise electrical contact pads of the microelectronic interconnection 140 that are used with solder or bump bonds to establish electrical connections between the optical chiplet 150 and the VLSI chip 110, and there may or may not be another receiving structural feature formed on the receiving surface 111 of the VLSI chip 110 for the optical chiplet 150.

Although the optical chiplets 150 are mounted on VLSI chips 110 in the illustrated examples of FIG. 1A and FIG. 1B, in other implementations the optical chiplets 150 can be mounted on PIC chips. For example, an active optical device 160 on an optical chiplet 150 can optically couple to an optical device or component on a PIC on which the optical chiplet 150 is mounted. In some implementations, the optical chiplet or PIC of the combined pair can be mounted on a VLSI chip 110.

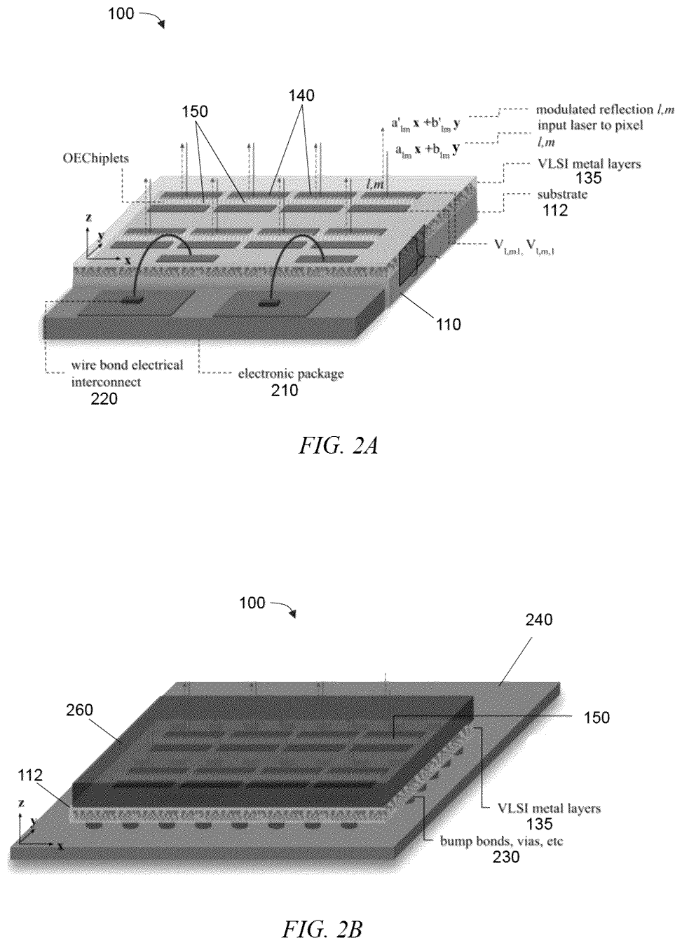

FIG. 2A depicts another example of an integrated EO device 100 that comprises a plurality of optical chiplets 150 mounted to a VLSI chip 110. The optical chiplets 150 can be mounted over conductive interconnects 135 of VLSI metal levels on the VLSI substrate 112. In this example, the optical chiplets 150 each comprise a one-dimensional (1-D) photonic crystal (PhC) cavity that functions as an active mirror for which the reflectivity of the mirror can be changed by an applied control signal (e.g., an optical pump beam, an applied electric field or current). The array of optical chiplets 150 provide an array of controllably reflective pixels with pixel indices l, m. The 1-D PhC cavities can be formed from electro-optic or magneto-optic material so that the reflectivity at each pixel can be modulated with control signals applied to interconnects 140 for each pixel from the underlying VLSI chip 110. The integrated EO device 100 can be implemented in an electronic package 210, a portion of which is shown. Wire bonds 220 can be used to make electrical connections from the electronic package 210 to circuitry on the VLSI chip 110.

FIG. 2B depicts another way in which electrical connections can be made to circuitry on the VLSI chip 110. Electrical connections from a PCB 240 or package substrate can be made using bump bonds 230 and conductive vias to the conductive interconnects 135. In this implementation, the VLSI chip 110 with optical chiplets 150 is flip-chip mounted on the PCB 240. Optical channels to the optical chiplets 150 (located between the VLSI chip 110 and PCB 240) can couple vertically through the VLSI substrate 112 and through regions free of the conductive interconnects 135. In some cases, substrate 112 can be at least partially removed by polishing or selective etching to thin the VLSI chip 110 and reduce optical losses when coupling through the chip to and from the optical chiplets 150. A protective layer 260 (e.g., a transparent polymer or oxide) can be formed over the integrated EO device 100.

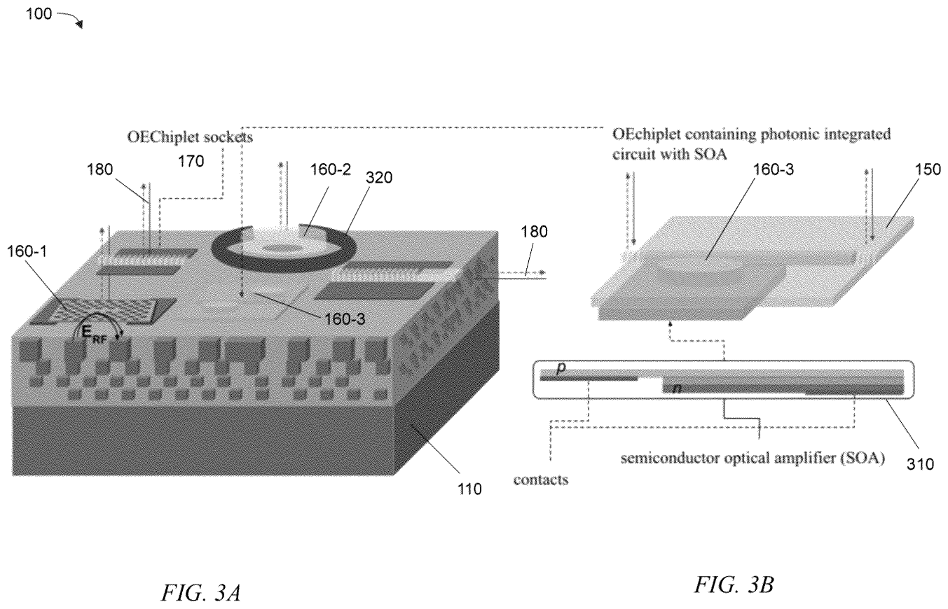

FIG. 3A depicts another example of an integrated EO device 100 that comprises a plurality of different optical chiplets having different active optical devices. The first active optical device 160-1 comprises an electro-optic 2-D PhC cavity reflector. A second active optical device 160-2 comprises a magneto-optic disk resonant reflector which can be controlled with a magnetic field induced by an inductor 320. Current can be driven through the inductor by circuitry on the VLSI chip 110 to generate a magnetic field. A third active optical device 160-3 comprises an SOA for which further details are depicted in FIG. 3B. The SOA can be coupled to one or more nanophotonic disk or ring resonators. In some implementations, the SOA is formed on the optical chiplet 150. In some cases, the SOA can be formed on a semiconductor chiplet 310 that is bonded to the optical chiplet 150 prior to mounting the optical chiplet 150 on the VLSI chip 110. The integrated EO device 100 can further include waveguides and optical gratings which may be vertically coupled, or edge coupled, to optical beams 180.

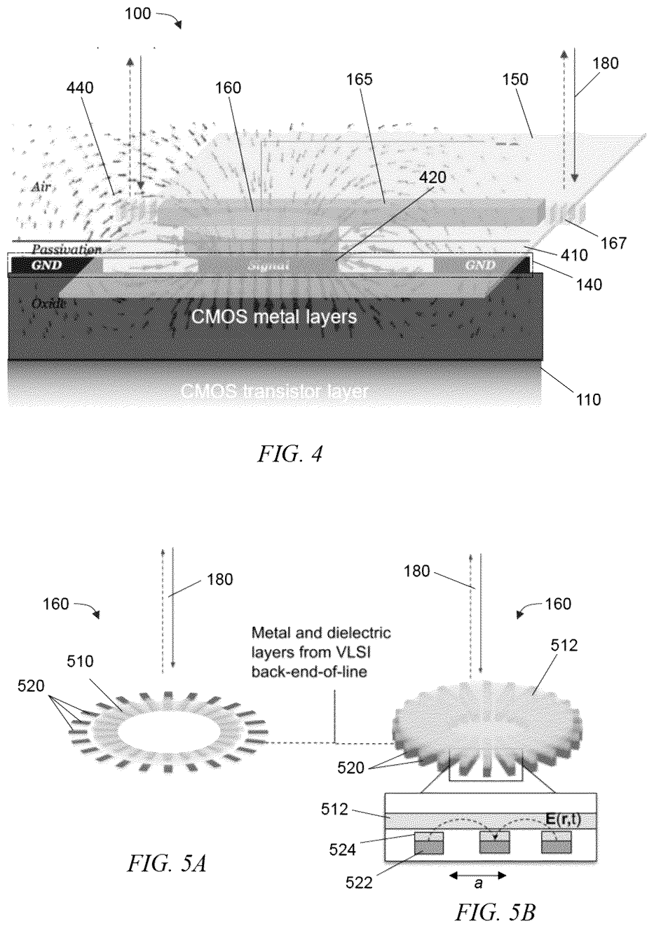

FIG. 4 illustrates one way in which an active optical device 160 on an optical chiplet 150 can be controlled by signaling provided via a microelectronic interconnection 140 from the VLSI chip 110. Signals from the VLSI chip can be routed through CMOS metal layers to apply a voltage to at least one contact 420 of a microelectronic interconnection 140, producing an electric field 440 (indicated by the arrows). Changing the amplitude and polarity of the voltage can change the strength and direction of the electric field 440, respectively. The electric field 440 can pass through the active optical device 160 to change its optical property (e.g., by changing the refractive index of the material from which the active optical device 160 is formed). In this example, the active optical device 160 can comprise a micro-disk resonator formed from lithium niobate. By changing the refractive index of the micro-disk resonator, the amount of light and/or frequency of light passing through the coupled waveguide 165 can be controlled.

In some implementations, an optically-transparent passivation layer 410 can be deposited over the VLSI chip 110. The passivation layer 410 can comprise a glass (e.g., a spin-on glass, an oxide, etc.) or polymer (e.g., polyimide, polymethyl methacrylate, etc.). The passivation layer 410 can separate the optical components on the optical chiplet 150 from metal electrodes on the VLSI chip 110. Such separation can reduce interaction of optical modes on the optical chiplet 150 with the metal electrodes and thereby reduce optical losses in the system.

As illustrated in the example implementation of FIG. 4, the electric field 440 established by the CMOS metal contacts overlaps with the active optical device 160 of the optical chiplet 150. This co-location of electric field 440 and active optical device 160 can be designed through numerical simulation to increase electric field concentration in the active optical device 160 and enhance modulation depth and speed. Due to short electrical interconnects on the VLSI chip 110 to affect the active optical device 160, RF modulation speeds over 10 GHz are possible. The juxtaposition of electronic components of the VLSI chip 110 and photonic components of the optical chiplet 150 can also provide efficient modulation at low energies.

Coupling of the optical chiplet 150 to electronic VLSI chip 110 shortens the propagation length, L_{AC}, of the electrical signal from conventional lengths of 1 millimeter or more (L_{AC}>1 mm) to lengths between 100 microns and 500 microns in some cases, between 50 microns and 200 microns in some cases, and even between 10 microns and 100 microns in some cases. A short L_{AC} can enable high-frequency electronic signals (e.g., high-frequency modulation from approximately or exactly 10 GHz to approximately or exactly 50 GHZ), where mixed-signal VLSI becomes very difficult due to complex waveform propagation. The optical chiplet approach described herein can keep even THz-frequency signals in the effective “near-field” regime. For the near-field regime with AC signals, the AC signal propagation distances d_{AC} should be much less than the wavelength λ of the signal (d_{AC}<<2). For reference, λ is on the order of 300 microns for a frequency v of about 1 THz.

FIG. 5A depicts another example of an active optical device 160 that can be included in an integrated EO device 100. The active optical device 160 comprises a thin-film electro-optic micro-disk or micro-ring resonator 510 which can be patterned on the optical chiplet 150. In some implementations, a grating can be etched into the micro-disk or micro-ring resonator 510. The evanescent field on periodic dielectric structures having a periodicity a approximately equal to the effective-wavelength λ_{eff} of light in the structure produces a vertical grating coupler to couple an optical beam 180 into and out of the resonator 510. The metal electrodes 520 beneath the structure can be used to produce electric field overlapping with the electro-optic material of the resonator 510, causing dielectric index variations. These index variations affect coupling of the optical fields between adjacent mode indices m and m±1 to change optical coupling into and out or the resonator 510. In an alternative implementation that does not include electrodes 520, an external optical pump can apply an optical field to the resonator to alter the resonator's index by means of the photorefractive effect. The diameter of the micro-disk or micro-ring resonator 510 can be from approximately or exactly 10 microns to approximately or exactly 50 microns, or any subrange within this range. The electrodes 520 can be patterned on the VLSI chip and may be part of the socket 170 and/or microelectronic interconnection 140 on the VLSI chip 110 (FIG. 1A).

FIG. 5B depicts another example of an active optical device 160 that can be included in an integrated EO device 100. In this example, a micro-disk resonator 512 (which can be patterned on an optical chiplet) is placed on electrodes 520 formed on the VLSI chip. The electrodes comprise a conductive metal layer 522 and a dielectric layer 524 disposed between the metal layer 522 and the micro-disk resonator 512. In this implementation, the micro-disk resonator 512 may not include an etched grating pattern. Instead, the grating can be provided by patterning the electrodes 520 of the VLSI chip with the desired periodicity a for vertical coupling of the optical beam 180. The dielectric layer 524 can space the micro-disk resonator 512 away from the metal layer 522 to reduce optical loss in the micro-disk resonator 512. It is also possible to use a micro-ring resonator instead of the micro-disk resonator 512 for the implementation of FIG. 5B. The diameter of the micro-disk or micro-ring resonator can be from approximately or exactly 10 microns to approximately or exactly 50 microns, or any subrange within this range.

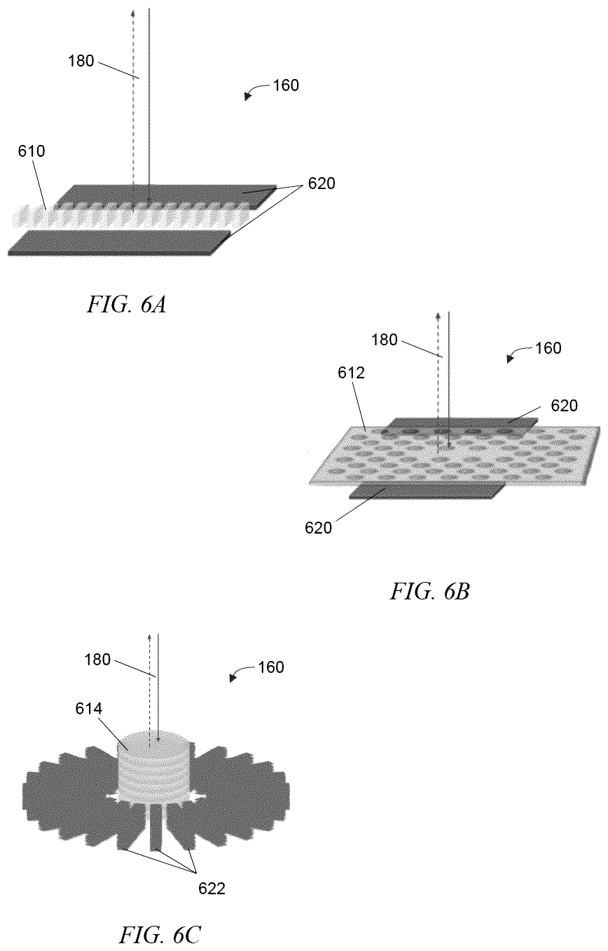

FIG. 6A depicts another example of an active optical device 160 that can be included in an integrated EO device 100. In this example, the active optical device 160 comprises a one-dimensional photonic crystal cavity 610 (a grating) which can be patterned in electro-optic material on the optical chiplet. The one-dimensional PhC cavity 610 can be placed between and/or adjacent to electrodes 620 formed on the VLSI chip. Voltages can be applied to the electrodes 620 from circuitry on the VLSI chip to create electric fields that permeate through the one-dimensional PhC cavity 610 for altering the refractive index of the electro-optic material and controlling reflectivity of the one-dimensional PhC cavity 610. Alternatively, the one-dimensional PhC cavity 610 can be optically pumped to induce the change in refractive index.

FIG. 6B depicts an active optical device 160 similar to that of FIG. 6A, except that a two-dimensional PhC cavity 612 is used. As with the one-dimensional PhC cavity 610 of FIG. 6A, the dielectric perturbation of the refractive index can be produced by an electric field generated between the electrodes 620 when voltages are applied to the electrodes 620 from the VLSI chip. Alternatively, the two-dimensional PhC cavity 612 can be optically pumped to induce the change in refractive index.

FIG. 6C depicts another example of an active optical device 160 that can be included in an integrated EO device 100. In this example, a distributed Bragg reflector (DBR) 614 can be patterned on an optical chiplet and placed between electrodes 622 formed on a VLSI chip. The DBR 614 can comprise one or more layers of an electro-optic material having a refractive index that can be modulated by an electric field produced by the electrodes 622. The electrodes 622 can include a plurality of bar-shaped electrodes as shown in the drawing (which may be controlled individually or in groups) or can comprise two or more sections forming parts of an annular electrode extending around the DBR 614. For example, the electrodes 622 can be two half-annular electrodes that generate an electric field passing through the DBR 614 in a direction mostly transverse to the propagation of the optical beam 180 in the DBR 614.

A number of cavity-based optical transmitters can be implemented on an optical chiplet 150. Such transmitters, which can be driving with digital signals on the VLSI chip 110, can comprise nanophotonic resonators of the active optical devices 160 illustrated in FIG. 5A through FIG. 6C. In some cases, the optical chiplets 150 may be fabricated using partial etch techniques to define a full membrane with ridge waveguides. Nanophotonic resonators can incorporate or be formed from electro-optic or magneto-optic materials to enable control over the phase and/or amplitude of the optical signal. This control is used to encode information onto the optical carrier wave that resonates in the nanophotonic resonator. In some cases, nanophotonic resonators can provide optical amplification. For example, a nanophotonic resonator can incorporate gain medium, such as gain material for a semiconductor optical amplifier or for a solid-state laser. Gain material for the solid-state laser could be pumped with an SOA.

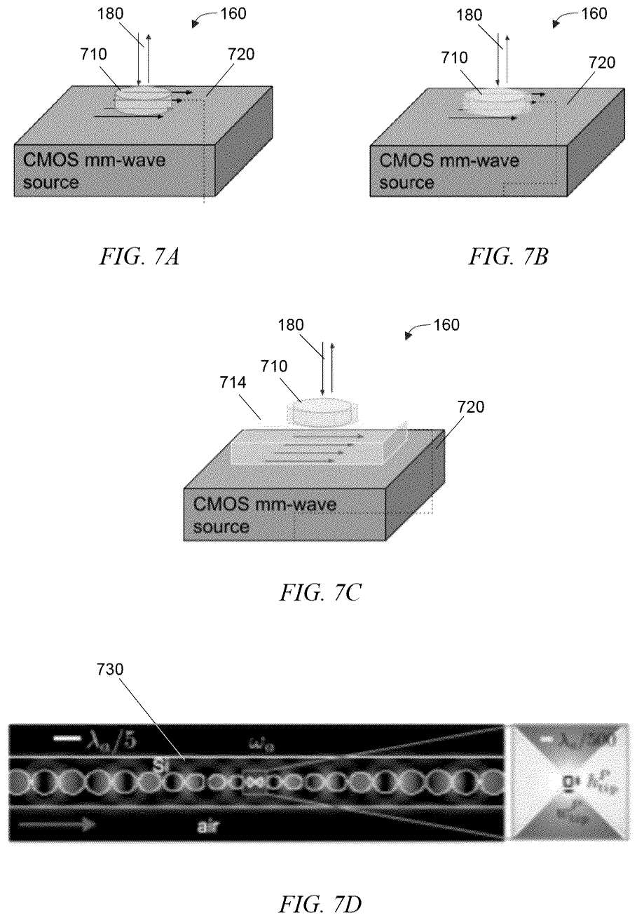

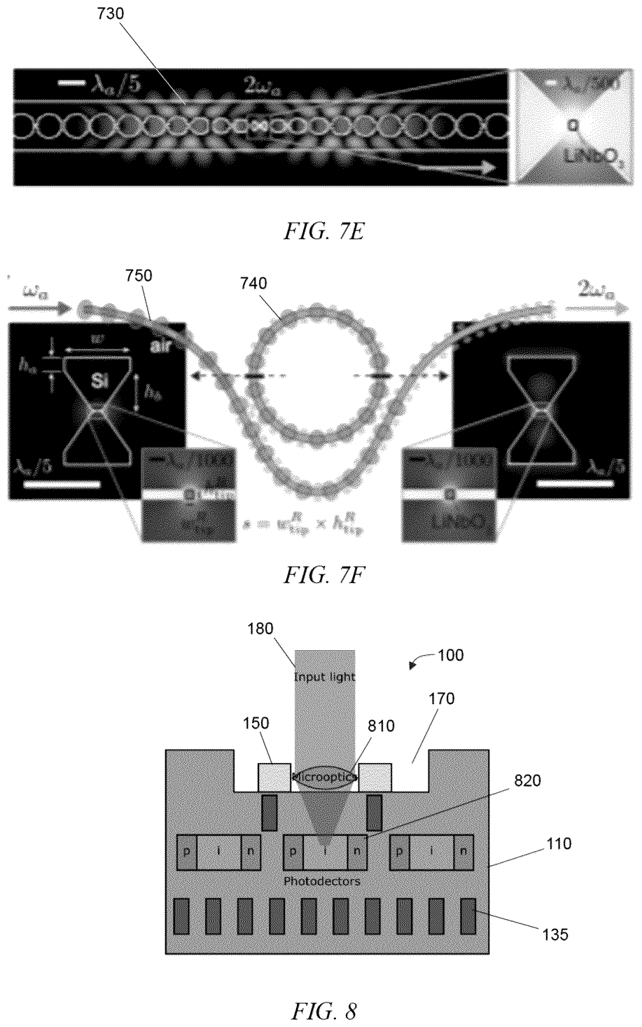

FIG. 7A depicts another example of an active optical device 160 that can be included in an integrated EO device 100. In this example, a micro-disk resonator 710 formed on an optical chiplet is placed in contact with or close proximity to a CMOS mm-wave source 720 fabricated on the VLSI chip. The resulting integrated EO device 100 can be used to generate an optical comb and/or encode data onto the optical carrier frequency of an optical beam 180 coupled into the micro-disk resonator 710. According to some implementations, the mm-wave source 720 (with modulation frequencies ORF on the order of 50 GHz to 200 GHz) can directly couple RF analog or digital signals to the optical mode in the micro-disk resonator 710 via the Pockels effect (through the second-order susceptibility χ⁽²⁾ of the material from which the micro-disk resonator 710 is formed).

FIG. 7B depicts another example of an active optical device 160 that can be included in an integrated EO device 100, similar to that of FIG. 7A. In this example, the CMOS mm-wave source 720 excites phonon modes (acoustic or transverse optical phonons) which can then couple to the optical mode in the micro-disk resonator 710 via the Pockels effect.

In another approach, depicted in FIG. 7C, the CMOS mm-wave source 720 excites phonon modes in a dielectric resonator 714, which concentrates electric field to drive phonon modes (transverse optical phonons) in the micro-disk resonator 710. The phonon modes in the micro-disk resonator 710 can then couple to the optical mode in the resonator via the Pockels effect. The dielectric resonator 714 may or may not be fabricated on the VLSI chip as part of a zero-change VLSI process. In some cases, the dielectric resonator 714 is placed on the VLSI chip after fabrication of the VLSI chip. The optical chiplet containing the micro-disk resonator 710 can then be mounted to the VLSI chip with the micro-disk resonator 710 disposed adjacent to the dielectric resonator 714. The term “adjacent” as used herein can mean in contact with or near (e.g., within 100 microns), in which case there may or may not be one or more intervening layers between the adjacent components.

FIG. 7D depicts an example of a one-dimensional PhC cavity 730 formed from a silicon waveguide. A central portion of the PhC cavity 730 is shown. The one-dimensional PhC cavity 730 can be formed on an optical chiplet and used for second-harmonic generation. The optical field is concentrated at the center of the PhC 730 where second-harmonic generation occurs. The center of the PhC cavity 730 comprises an optically non-linear material (such as lithium niobate) to generate the second harmonic frequency. FIG. 7E depicts the electric field intensity for the generated second-harmonic wave in the PhC cavity 730. According to some implementations, the PhC cavity 730 can be placed over a CMOS mm-wave source on a VLSI chip to couple mm-wave or RF frequencies to the second-harmonic generated optical signal.

FIG. 7F depicts another approach to second-harmonic generation. In this approach, a ring resonator 740 containing a nonlinear material (lithium niobate) is used. The optical field is concentrated into the nonlinear material at two places in the ring resonator (depicted with the adjacent enlarged images). The ring resonator 740 can be pumped with a fundamental wavelength (having an optical frequency ωₐ) via a bus waveguide 750. After conversion by the ring resonator 740, the coupled waveguide 750 can output the second harmonic (frequency 20ωₐ). The coupled waveguide 750 and ring resonator 740 can be patterned on an optical chiplet and placed over a CMOS mm-wave source fabricated on a VLSI chip (e.g., to encode signals onto the second harmonic wave.

By combining optical resonators on optical chiplets 150 with multiple channelized RF electronic oscillators (which can be done as described above in connection with FIG. 7A through FIG. 7F) it is possible to program complex optical waveforms with analog control signals or digital signals applied to the electronic oscillators. In one approach, lithium niobate ring resonators on optical chiplets 150 can be used to couple analog or digital signals from DC to 300 GHz or more from an RF oscillator on the VLSI chip 110 with optical fields. Previously, it has not been possible to generate large frequency spacings in RF combs because of the difficulty of producing and then transmitting high-frequency (>50 GHz or so) modulated signals from the RF source via a transmission line to the optical resonator. In the approaches described above, the transmission-line problem is avoided since no RF transmission line is used. Instead, the electro-optic resonator is placed directly in the near-field of an RF oscillator implemented on the VLSI chip 110, as illustrated in FIG. 7A through FIG. 7C. Such an RF comb generation system can make use of one or more of the following features.
Lithium Niobate Ring Resonator with Built-In Grating Couplers: A lithium niobate (LN) ring resonator (which may or may not include built-in grating couplers) formed on the optical chiplet 150 can be placed onto or in close proximity to (e.g., within 50 microns of) a high-frequency (e.g., 50 GHz to 300 GHz) RF oscillator formed on a VLSI chip. The RF oscillator can be fabricated using materials with high fₘₐₓ transistors, such as high-electron-mobility transistors (HEMTs) in gallium nitride (GaN) or advanced silicon CMOS.
Extending to High-Frequency, High-Q, Small-Confinement mm-Wave Cavities: Conventional approaches to RF frequency combs have been limited to relatively low comb-generation RF frequencies (well under 50 GHz). The use of integrated optical chiplets 150 can extend RF comb generation to high-frequency (e.g., 50 GHz to 300 GHz), high-Q, small-confinement, millimeter-wave (mm-wave) cavities. The integration of optical chiplets 150 to VLSI chips 110 can couple mm-wave RF resonators to nanophotonic resonators as described above.

The creation of RF combs with regular spacing in the range of 50-200 GHz has several desirable features. The frequency spacing of the comb teeth can meet telecom standards (such as ITU). In one approach, a single input laser (e.g., a semiconductor laser) can be used with an integrated electro-optic device 100 to produce the ITU grid of communication channels. By selectively modulating electrodes, one can selectively drive couplings between the primary laser mode m (the one that is pumped by the external laser) and other modes (e.g., m±1) by electrically controlled multimode dispersion as described in H. Larocque and D. Englund, Universal Linear Optics by Programmable Multimode Interference, Opt. Express 29.23 (2021): 38257-38267, which publication is incorporated herein by reference in its entirety. Holographic patterning of the EO material can also induce the multimode scattering through the photorefractive effect. This effect has been used in the field of holographic data storage. Resonant interactions in micro-rings can also greatly enhance multimode scattering via the holographically patterned material. By extending to high-frequency, high-Q mm-wave cavities, integration of optical chiplets 150 as described herein is well-suited for applications involving RF combs.

Photodetection is a process in optical communication systems where incoming optical signals are converted into electrical signals that can be processed by the system. Traditional photodetection methods rely on semiconductor detectors to perform this conversion. In some cases, photodetectors can be implemented on the optical chiplet 150 and an electrical connection made between the optical chiplet 150 and the VLSI chip 110 to handle photovoltage or photocurrent. The electrical connection can be capacitive, inductive, or ohmic, as described further below.

IC platforms typically include semiconductor layers in their design stacks. These semiconductors can have bandgaps suitable for photodetection, such as silicon's bandgap for visible wavelengths and germanium's bandgap for the near infrared. Forming p-i-n or p-n junctions from these semiconductors or from compound semiconductors in the VLSI chip 110 provides another way of incorporating photodetection in an integrated EO device 100. However, the position of the photodetectors formed in the VLSI stack may not be suitable for some applications.

FIG. 8 depicts an example of an integrated EO device 100 that includes a passive micro-optical component 810 formed on an optical chiplet 150. In this example, the micro-optical component 810 comprises a microlens which can be formed on the optical chiplet 150 that is subsequently placed in a socket 170 of the VLSI chip 110. The microlens can be a molded optic or formed by two-photon lithography processes. The microlens can focus light from a received optical beam 180 onto the carrier-generation region of a photodetector 820 formed deep in the VLSI chip 110. The photodetector 820 can be a p-i-n photodiode as shown or a p-n photodiode and can connect to conductive interconnects 135 in the metal levels of the VLSI chip 110 for biasing and/or signal readout. There can be a plurality of optical chiplets 150 with the same micro-optical component 810 and a plurality of photodetectors 820 arrayed across the VLSI chip 110 to form an imaging array for acquiring electronic images of scenes. Alternatively, the EO device of FIG. 8 can be used as a compact high-speed sensor or compact photodetector (e.g., in a receiver for optical communications).

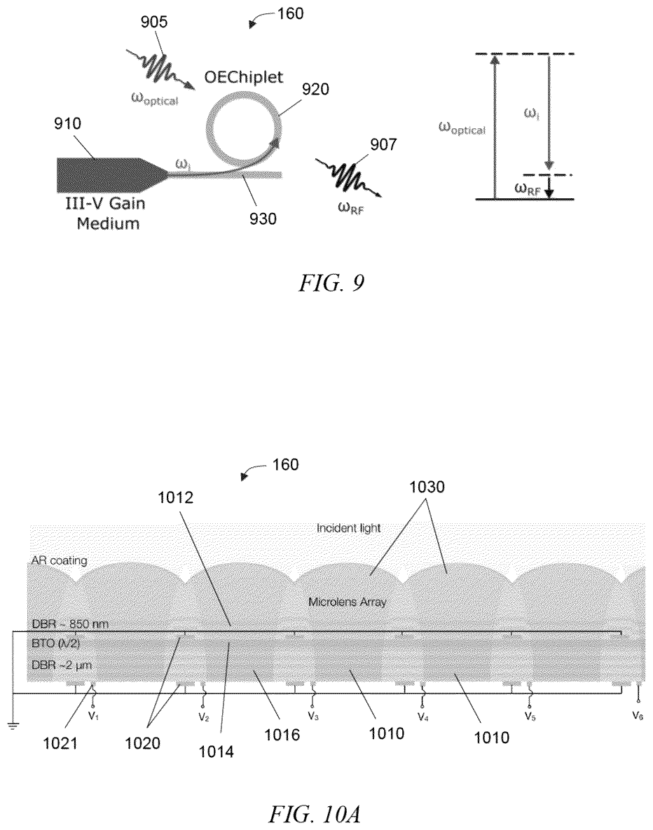

An alternative approach to photodetection employs difference-frequency generation (a form of three-wave mixing) to achieve optical-to-RF conversion, as depicted in FIG. 9. Difference-frequency generation is a nonlinear optical process that involves the interaction of three different optical waves (referred to as a pump wave, a signal wave, and an idler wave) within an optically nonlinear medium. In the context of photodetection, this process can be used to convert a received optical beam encoding information into an RF signal containing the encoded information. The received optical beam interacts with another optical wave (the idler) in a medium that supports difference-frequency generation. Through this nonlinear optical interaction, the two input optical waves generate an output wave (the RF signal) at the difference frequency. This RF signal carries the same information that was encoded onto the received optical beam previously (e.g., encoded by an RF electro-optic modulator) but in a form that can be directly processed by the RF components fabricated on the VLSI chip 110.

FIG. 9 depicts an active optical device 160 for difference-frequency generation that can be included in an integrated EO device 100. The device can be used as an RF detector to receive optical signals 905 encoding information at radio frequencies and convert the received optical signal to the RF signal 907. The device comprises a pump source 910, a micro-ring resonator 920, and a bus waveguide 930. According to some implementations, a stampable pump source 910 (e.g., a laser based on a III-V gain medium) is mounted on the VLSI chip to provide the idler wave. The pump source 910 can be formed on a first optical chiplet. A second optical chiplet can include the bus waveguide 930 and micro-ring resonator 920 and be mounted on the VLSI chip such that the pump source 910 pumps laser light into the bus waveguide 930 at the idler frequency ωᵢ of the difference-frequency generation process, ω_{optical}−ωᵢ=ω_{RF}. The micro-ring resonator 920 can include a grating patterned in the resonator to couple the received optical signal 905 into the micro-ring resonator 920. An energy diagram for the corresponding difference frequency generation process is shown to the right of the active optical device 160.

Using difference-frequency generation for photodetection offers several benefits which are listed below.
Coherent and Lossless in Principle: The difference-frequency generation process is an optically coherent and lossless process in principle. As such, difference-frequency generation can be suitable for quantum state transduction from an optical to a microwave or mm-wave fields, which is important for applications like quantum computing or precision sensing.
Extended Spectral Range: Difference-frequency generation is a tunable process, in the sense that the frequencies of all the waves can be adjusted. The requirement is that the RF signal and idler frequencies sum to the frequency of the pump wave. Thus, pump waves (optically received beams encoding information) with lower frequencies in the infrared can be used (and still provide conversion to an RF signal) provided there is a material to support difference-frequency generation at the longer wavelengths. As such, difference-frequency generation can push detection further into the infrared than is possible with semiconductor bandgap photodetection. For efficient difference-frequency conversion, small-volume optical and microwave cavities are preferred to support the difference-frequency generation process. Such small cavities are compatible with the optical chiplets 150 described herein.
Flexibility: Because of its tunability, the difference-frequency generation process can be adapted for different applications. For example, the nonlinear optical material that supports difference-frequency generation and the frequencies of the mixed waves can be chosen based on the requirements of the application.

As shown in FIG. 9 difference frequency generation can be seeded with the pump source 910 that pumps the nonlinear medium (micro-ring resonator 920) with an optical field oscillating at the frequency of the idler (ω_{optical}−ω_{RF}). Increasing the intensity of the idler wave in the nonlinear medium can increase the conversion rate of the received optical wave to the RF signal, thereby increasing the efficiency of the difference-frequency generation process as a detection mechanism. Theoretically, the conversion rate of the optical wave to the RF signal increases in proportion to the square root of the power, or the mean photon number, of the idler field in the nonlinear medium. Without the pump source 910 generation of the RF signal (and the idler) may occur by spontaneous parametric down conversion, though the conversion efficiency may be less than when a pump source 910 is used. This idler wave can be considered a byproduct of the conversion process and filtered out or utilized in other parts of the system, depending on the application.

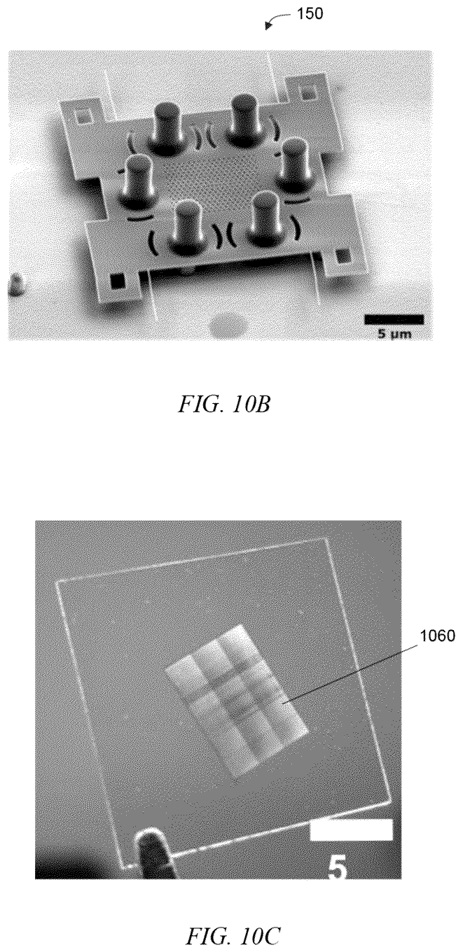

FIG. 10A depicts an example of an active optical device 160 that can be fabricated on an optical chiplet. The device comprises an array of electro-optic resonators 1010 having an array of microlenses 1030 formed over the array of resonators. The optical resonators 1010 each comprise a top DBR 1012, a layer of electro-optic material 1014 (barium titanate (BTO) in this example), and a bottom DBR 1016. Voltages from the VLSI chip can be applied to electrodes 1021 generate an electric field in the layer of electro-optic material 1014 and change the reflectivity of the electro-optic resonator 1010. Top electrodes for the array of microlenses 1030 can be formed within the optical chiplet. The bottom electrodes (below the bottom DBR 1016 in the drawing) can be formed on the optical chiplet and electrically connect to mating electrodes on the VLSI chip, as depicted in the microelectronic interconnection 140 of FIG. 1B. Alternatively, the bottom electrodes can be formed on the VLSI chip. The active optical device 160 of FIG. 10A can be used as a high-speed spatial light modulator (SLM), each optical resonator 1010 forming, at least in part, a pixel that is controlled by the small electrode 1021 coupled to the pixel.

It may be appreciated from the foregoing discussion that in-line modulators, resonant modulators, and waveguide interference modulators can be fabricated on optical chiplets 150 and integrated onto VLSI chips 110, providing a versatile approach to optical modulation. Such modulators can be implemented using liquid crystal phase modulation, phase change materials for adaptability, or phase-amplitude modulation by free-carrier dispersion (injection/depletion). Additionally, the Franz-Keldysh effect and quantum-confined Stark effect, as well as the Kerr electro-optic effect and Pockels effect can be utilized for modulation with active optical devices 160 fabricated on optical chiplets 150. By leveraging these diverse technologies, the integration of optical chiplets as described herein can provide scalable and efficient solutions for optical interfaces with VLSI IC chips, addressing challenges of size, complexity, and energy consumption.

### 3. Materials for Active Optical Devices

Various material platforms and mechanisms are considered for fabricating active optical devices 160 on optical chiplets 150 such as the active optical devices described above.

Thin-film materials can be used to fabricate active optical devices 160 described herein. For example, thin-film materials may be used to implement optical modulators in optical transmitters (TX) and optical receivers (RX) formed, at least in part, on an optical chiplet 150. Example thin-film materials include, but are not limited to:
Thin-Film Lithium Niobate (TFLN): TFLN is an electro-optic (EO) material having a strong electro-optic effect, making it suitable for high-speed modulation, and commercial scalability.
Thin-Film Barium Titanate (TFBTO): TFBTO is another EO material that offers excellent Pockel's effect properties, allowing for efficient RF-optical signal processing.
Chalcogenide materials include EO materials that are suitable for operation in mid-IR and long-wave IR.

Thin-film semiconductors can also be used to fabricate active optical devices 160 on optical chiplets 150. Examples of thin-film semiconductors include, but are not limited to:
Silicon Membranes: Silicon membranes, which may be fabricated from silicon-on-insulator (SOI) wafers, provide compatibility with existing silicon-based technologies, facilitating integration with VLSI ICs. Recently, high-Q resonators in mass-producible PhC cavity devices with high (>90%) I/O coupling efficiency were demonstrated in silicon membranes. FIG. 10B is a scanning-electron-microscope image of such a high-Q PhC cavity resonator fabricated from a silicon membrane. The optical chiplet 150 has been transfer printed using methods described herein with placement accuracies at the micron level. FIG. 10C is a photograph of a centimeter-scale silicon membrane 1060 hosting more than a million high-Q resonators. The membrane 1060 could be placed as a single optical chiplet on a VLSI chip 110 (e.g., as part of a spatial light modulator).
III-V semiconductors such as GaAs, AlAs, and AlₓGa₁₋ₓAs compounds, and II-VI compounds: These materials provide a broad range of optoelectronic properties, suitable for strong Pockels effect (as in GaAs), chi-2 process (second harmonic generation, sum-frequency generation, spontaneous parametric down conversion, squeezed state generation, three-wave mixing, difference-frequency generation, etc.), or semiconductor optical amplification. III-V and II-VI semiconductor substrates are a cornerstone in the realm of semiconductor lasers and integrated photonic circuits. These substrates offer tunable energy bandgaps for precise control of the emitted wavelengths, enabling the creation of semiconductor lasers spanning a wide spectrum from visible to infrared light. This property is useful in telecommunications, medical devices, and scientific instrumentation. Moreover, III-V and II-VI substrates offer high electron mobility and efficient carrier transport, resulting in enhanced performance of laser diodes and photonic devices. Integrated photonic circuits benefit from III-V and II-VI substrates' ability to host multiple functionalities on a single chip, facilitating the development of compact, high-speed, and energy-efficient devices for optical communication and sensing.

Thin-film crystals can also be used to fabricate optical chiplets 150. Thin-film crystals can provide efficient interactions between optical fields, DC and AC electrical fields (DC-1 THz), and sound (e.g., acoustic phonon modes and optical phonon modes such as transverse optical phonon modes). Examples of thin-film crystals include, but are not limited to:
Silicon carbide: This material is suitable for high optical power, EO effects, nonlinear optical interactions (chi-2), and for hosting quantum emitters and quantum memories such as the Si-vacancy center, which can facilitate transduction of quantum mechanical states between electromagnetic frequencies in the optical and microwave, mm-wave, and THz frequency realms.
Diamond chiplets: Diamond is also suitable for hosting quantum emitters and quantum memories such as the Si-vacancy center, which can facilitate transduction of quantum mechanical states between electromagnetic frequencies in the optical and microwave, mm-wave, and THz frequency realms.
Rare-earth-ion doped glasses and crystals: These materials are also suitable for quantum memories (e.g., implemented with ions of erbium, europium, presidium, etc.) and can facilitate quantum state transduction of quantum mechanical states between electromagnetic frequencies in the optical and microwave, mm-wave, and THz frequency realms.

Piezoelectromechanical membranes can also be used to fabricate active optical devices 160. These membranes can provide electromechanical coupling to optical fields. These membranes can comprise thin-film layers of piezo materials such as aluminum nitride and silicon nitride.

Atomically-thin or nanoscale-thick opto-electronic materials (“2-D materials”) can be used to fabricate active optical devices 160 on optical chiplets 150. 2-D materials include graphene and stacks of transition metal dichalcogenide which may be supported on thin (10-500 nm thickness) support membranes. The support membranes can be made of passive materials such as SiN membranes. 2-D materials offer desirable properties for coupling optical fields to electrical signals, such as EO modulation at long wavelength (NIR to mid-IR to long-IR). Although previous work has stamped 2-D materials onto CMOS electronics, problems remain with placement accuracy, process yield, electrical connections, etc. In the optical chiplet approach described herein, 2-D materials can be incorporated onto the optical chiplet 150. The chiplets can be pre-screened to identify functional devices (e.g., devices for which electrical contacting succeeded), and then the functioning optical chiplets can be placed onto the VLSI chip using a more mature and robust pick-and-place process. Similarly, integrating 1-D materials (such as carbon nanotubes) and 0-D materials (such as self-assembled InGaAs semiconductor quantum dots or colloidal nanocrystals) becomes easier if they are first manufactured into optical chiplets 150 that can subsequently be placed onto the VLSI chips 110.

Combinations of the above materials can be used to form optical chiplets 150 that provide multifunctionality. For example, an EO material and thin film crystal can be used to make an optical chiplet 150 that provides optical read/write of quantum memory.

### 4. Methods of Fabrication

The integrated EO devices 100 described herein can be fabricated in several ways. One approach is to use pick-and-place machinery and techniques to place the optical chiplets 150 on the VLSI chip 110. Another approach is to use elastomer stamping methods that utilize locking of the optical chiplet 150 to a socket 170 on the VLSI chip 110. Integrating optical chiplets 150 onto foundry-fabricated zero-change VLSI chips 110 using these approaches can greatly streamline fabrication of integrated EO devices 100. Unlike conventional methods used for PICs, the mounting of optical chiplets 150 on VLSI chips 110 can eliminate long access and interconnect waveguides, thereby simplifying both fabrication and packaging of the integrated EO devices 100.

According to some implementations, the optical chiplets 150 can be stamped onto the VLSI chip 110, which is a departure from conventional PIC fabrication. An approach that mounts optical chiplets 150 to VLSI chips 110 can simplify the integration of photonics and electronics. By eliminating intricate interconnects and information aggregation/serialization sub-circuits, the integrated EO devices can enable high performance in a scalable and cost-effective manner. Photonic modulators can be mounted on and integrated with VLSI electronics, facilitating the distribution of receivers and transmitters across the VLSI chip 110.

An initial phase of fabrication involves design of the optical chiplet 150 and circuitry on the VLSI chip 110 that may interface with an active optical device 160 on the optical chiplet. The interplay between and co-design of electronic circuits and nanophotonic structures described herein can unlock new avenues in high-frequency signal processing. The integration of an LC electronic resonator and a lithium niobate micro-disk is an example of such a co-design. The design phase aims to harness a strong electric field from the LC resonator to modulate the optical mode in an optical resonator or other active optical device 160 located on the optical chiplet 150.

Design of the electronic LC resonator can involve targeting a resonant frequency based on the optical mode of the active optical device 160. Design work can employ the equations for LC resonators and optical resonators to separately simulate these components, then use perturbation theory to estimate their coupling when mounted in close proximity (e.g., within 50 microns or less from each other). VLSI design work can comprise selecting inductor and capacitor values that adhere to available CMOS metal layers and design constraints.

Once an initial design is determined, finite-difference time domain (FDTD) models and/or finite element models can be used to simulate optical performance for the active optical device 160. Additionally, electromagnetic simulations can be performed to determine a spatial distribution of the LC resonator's electric field and evaluate its interplay with the active optical device 160. The initial design can be iterated to improve performance of the active optical device 160 (e.g., increase modulation efficiency, increase modulation speed). During simulations, the position of the LC resonator with respect to the active optical device 160 can be varied to change the electric field and optical mode overlap, thereby improving modulation efficiency. Refinement of the LC resonator's design and positioning can be carried out to further improve electro-optical coupling between an electrical or magnetic field produced by circuitry on the VLSI chip 110 and the active optical device 160.

The design phase should adhere to CMOS fabrication constraints and design rules. For example, any design should consider thermal and mechanical attributes of the materials. Thermal and mechanical material properties can be relevant during the integration of the optical chiplet(s) 150 onto the VLSI chip 110 and during operation of the integrated EO device 100.

Testing and validation of devices can follow device fabrication. Tests can include evaluating the coupling efficiency between the LC resonator and the active optical device 160 (which may be done by measuring modulation efficiency, such as amount of phase change per applied voltage). Feedback from tests can be used to refine models used during the design phase.

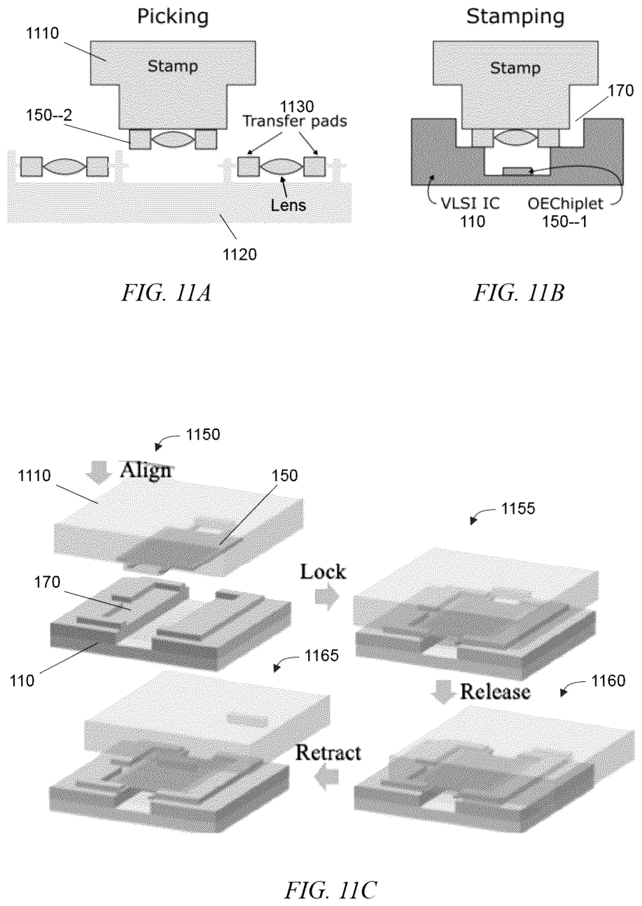

FIG. 11A and FIG. 11B depict an example of pick-and-place integration of an optical chiplet 150-2 into a socket 170 formed on a VLSI chip 110. The optical chiplet 150-2 comprises a passive lens and transfer pads. A stamp 1110 or a vacuum chuck can be used to pick the optical chiplet 150-2 from an array of similar chiplets and place the optical chiplet 150-2 in the socket 170. In this example, the optical chiplet 150-2 is placed in the socket 170 over another optical chiplet 150-1, which can comprise an active optical device 160 (not visible in the drawing).

In a micro-transfer printing approach, a manual, semi-automated, or automated apparatus comprising a micro-positioner stage, a stamp holder, and a microscope is used to pick and place the optical chiplets 150. The process can begin with a suspended optical chiplet 150 that is connected or tethered to a substrate 1120 on which the optical chiplet was formed. The optical chiplet 150 can be picked up by adhesion to a PDMS stamp, for example, which breaks the tethers upon lifting. Referring to process flow of FIG. 11C, the optical chiplet 150 can be aligned (step 1150) to the socket 170 on the VLSI chip 110. After being aligned with the socket 170 and/or microelectronic interconnection, the optical chiplet 150 is brought into contact with the VLSI chip 110. In some implementations, the socket 170 can lock (step 1155) the optical chiplet 150 in place to limit and/or prevent lateral motion of the optical chiplet 150 with respect to the VLSI chip 110. A small shear force can be applied to the stamp 1110 to release (step 1160) the optical chiplet 150 from the stamp 1110. The stamp 1110 can then be retracted (step 1165) to complete the transfer of the optical chiplet 150 onto the VLSI chip 110. This pick-and-place method has been tested by the inventors with various materials and substrates. It has been used to place silicon PhC cavities (with quality factors Q>10⁵) onto patterned heterogeneous substrates that emulate the VLSI host chip with micron-level alignment precision. The process can simplify fabrication of integrated EO devices 100. Of course, conventional pick-and-place instruments can be used to mount the optical chiplets 150 on the VLSI chips 110.

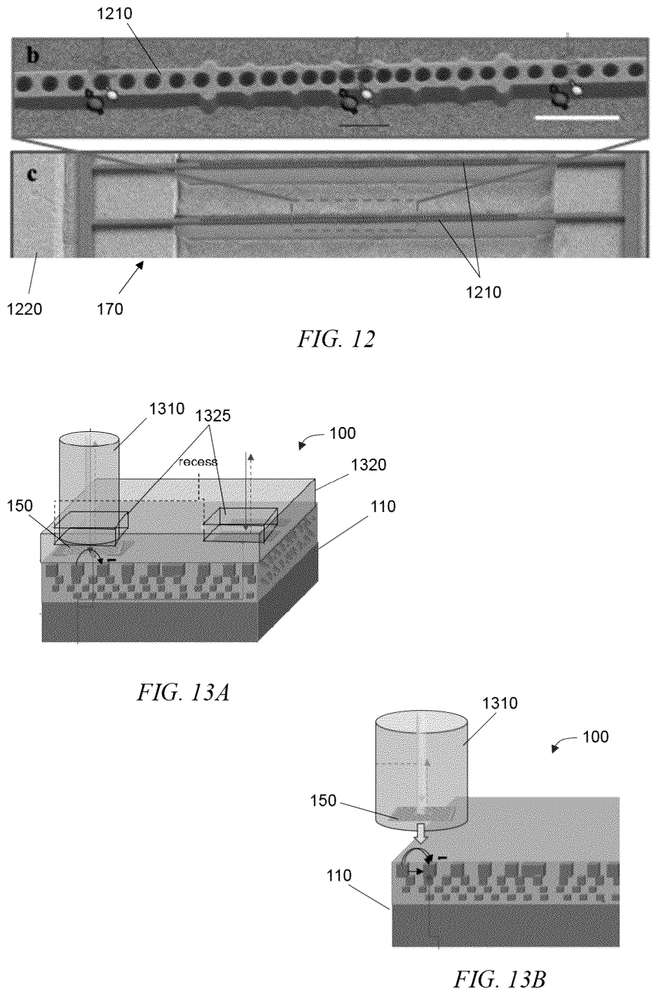

FIG. 12 shows a plurality of one-dimensional PhC cavity 1210 fabricated in diamond on an optical chiplet that has been placed in a socket 170 of a receiving chip 1220 using the approach illustrated in FIG. 11C. The one-dimensional PhC cavities 1210 (enlarged in the top image) are suspended in air across most of the socket 170.

Including additional on-chip micro-optics can improve the optical coupling efficiency between the optical chiplets 150 and an interfacing optical component via a free-space or fiber-link. For example, a micro-lens can reduce the mode field diameter of an optical beam propagating in free-space to something closer to the spatial extent of the mode supported by a vertical grating coupler, micro-disk, or DBR reflector of a nanophotonic resonator on the optical chiplet 150. Several methods now exist to fabricate such micro-optics, which include injection molding and two-photon lithography. However, only certain application-specific tools can directly write these micro-optics on arbitrary substrates.

The stamping approach described above in connection with FIG. 11A through FIG. 11C can be used to transfer print micro-optics, which have been manufactured by methods such as injection molding and two-photon lithography, onto the VLSI chip 110 to provide an improved interface with the optical chiplet 150, as depicted in FIG. 11B. The micro-optic structures can be formed in arrays on a substrate 1120. The micro-optic structures can each be formed on an optical chiplet 150-2 that can include structural features 1130 (transfer pads in the illustrated case) that can aid in mechanical placement and alignment of the micro-optical structures (a lens in the illustrated example). The stamp 1110 can anchor to the structural features 1130 to transfer the optical chiplet 150-2 to the VLSI chip 110. The structural features 1130 may further engage with the socket 170 to aid alignment of the optical component(s) on the optical chiplet 150-2 with optical components on another optical chiplet 150-1 or components on the VLSI chip 110. These structural features 1130 can be fabricated during the back-end-of-line metallization processes used in zero-change VLSI fabrication.

### 5. Microelectronic Interconnections

The microelectronic interconnections 140 can be implemented in various ways. Some example interconnects 140 are described in this section along with another type of interconnection to an environment external to the integrated EO device 100. The microelectronic interconnections 140 can provide relatively simple RF interfaces between the optical chiplet 150 and the VLSI chip 110. By reducing the complexity of these interfaces, the system can achieve higher efficiency and reliability.

FIG. 13A and FIG. 13B depict examples of optical fiber interconnects or links from the integrated EO device 100 to an external environment. In some implementations, free-space optical links to an external environment can be used. Fiber and/or free-space optical links enable the integrated EO device 100 to communicate with external devices and networks.

For the implementation of FIG. 13A, at least one recess 1325 can be formed in a capping layer 1320 disposed on the integrated EO device 100. The capping layer can be formed from a polymer or oxide and the recess can be etched into the capping layer 1320 to receive an end of the optical fiber 1310. The recess 1325 can be located such that the core of the optical fiber 1310 aligns with an optical input and/or output of the optical chiplet 150. The optical input and/or output can be a grating coupler, nanophotonic resonator, DBR, lens, or another optical component formed on the optical chiplet 150. In some implementations, the recess 1325 can be larger than the diameter of the optical fiber 1310 so that the fiber can be positioned within the recess, aligned to the optical input and/or output on the optical chiplet 150 to maximize coupling efficiency, and then bonded in place (e.g., with a UV-curable adhesive).

For the implementation of FIG. 13B, the optical chiplet 150 is first aligned to and mounted on the optical fiber 1310. The optical fiber 1310 and mounted optical chiplet 150 can then be aligned to, coupled to, and bonded to the VLSI chip 110. The VLSI chip 110 may or may not include a capping layer 1320 with recesses 1325 to aid in alignment and bonding of the optical fiber 1310 to the VLSI chip 110.

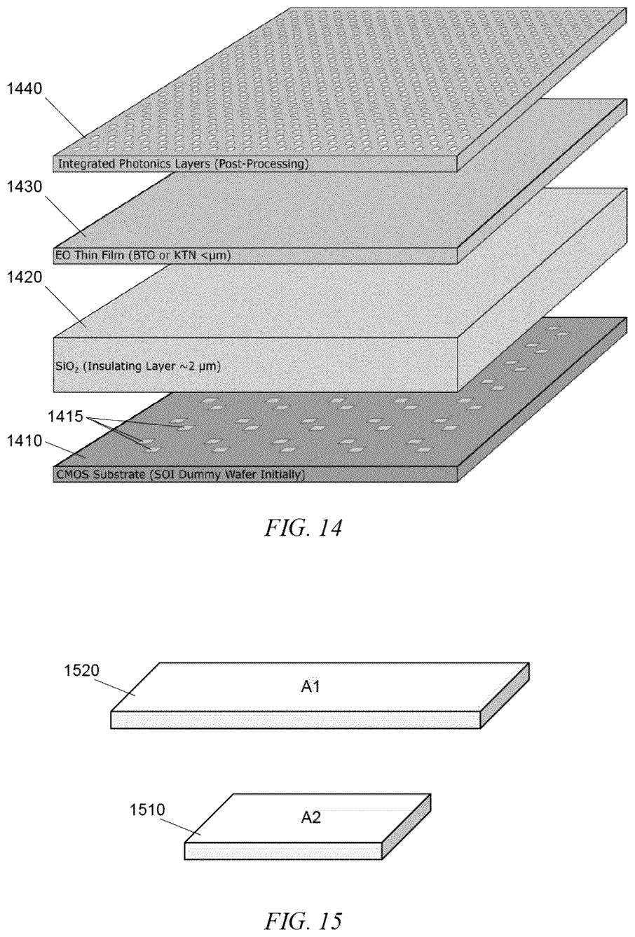

Returning to the chip level, capacitive, inductive, and ohmic microelectronic interconnections 140 between the optical chiplet(s) 150 and the VLSI chip 110 can provide a straightforward integration process of the optical chiplet(s) 150 to the VLSI chip 110. By making use of existing electrical connection technologies, the need for complex photonic components is reduced, further simplifying the overall system design. FIG. 14 illustrates an example of a microelectronic interconnection approach where an electro-optic thin film 1430 is capacitively coupled via electrodes 1415 to a VLSI backplane 1410 for out-of-plane electrical control. This approach avoids the 1-D scaling limit faced by single in-plane integrated photonics: the area of a control aperture scales as A, but the perimeter through which control wires can be routed scales as A^{1/2}. The VLSI backplane 1410 may or may not be covered by a passivation layer 1420. In this example, the EO thin film 1430 and integrated photonics layer 1440 can be disposed on an optical chiplet 150.

In a capacitive microelectronic interconnection 140 as depicted in FIG. 1A and FIG. 15, an EO membrane 1520 lies on the optical chiplet and has an area A₁. A metal electrode 1510 lies on the VLSI chip and has an area A₂. The size of A₁ can be equal to or greater than A₂ and can be as large as the size of unit cell for a device formed in an array of devices (e.g., the size of a pixel in an SLM). An insulator, which could be an air gap or an oxide layer on the VLSI back end, can be disposed between the EO membrane 1520 and the electrode 1510. The EO membrane can function as a “floating gate” and is charge-neutral. This arrangement can allow for local doping control despite the absence of Ohmic contacts. This capacitive contact configuration eliminates the need for Ohmic bonding processes, such as wire bonds and vias, thereby simplifying the hybrid chip integration process.

The system is governed by equations that relate applied voltage (V_{A}), charge (Q), and capacitances (C₁, C₂) in the two areas. These equations can be solved to yield the surface charge densities (Σ₁ and Σ₂) normalized by V_{A}. Shifting charges between these different regions enables the achievement of various EO functionalities, including semiconductor optical amplifiers (SOAs) and photodetection, without requiring electron or hole transfer between the EO membrane 1520 and the VLSI chip. In example implementations, photodetectors and/or nonlinear optical function units can be implemented on the optical chiplet and capacitively coupled to the VLSI chip.

Upon simplification, the normalized surface charge densities Σ₁/V_{A} and Σ₂/V_{A} are given by:

$$\frac{{\sum }_{1}}{{V}_{A}} = \frac{{C}_{1} ( - {A}_{2} {V}_{A} {C}_{2} + {Q}_{app} )}{{V}_{A} ( {A}_{1} {C}_{1} + {A}_{2} {C}_{2} )} \qquad ( 1 )$$

$$\frac{{\sum }_{2}}{{V}_{A}} = \frac{{C}_{2} ( {A}_{1} {V}_{A} {C}_{1} + {Q}_{app} )}{{V}_{A} ( {A}_{1} {C}_{1} + {A}_{2} {C}_{2} )} \qquad ( 2 )$$

These expressions indicate that the charge distribution on the areas A₁ and A₂ can be tuned by adjusting the applied voltage V_{A}, which adjusts the total charge Qₐₚₚ.

Ohmic microelectronic interconnections 140, as depicted in FIG. 1B, can establish a direct electrical connection between electrical circuitry on the optical chiplet 150 and electrical circuitry on the VLSI chip 110. Methods for forming these contacts include gold thermo-compression bonding, which involves the application of heat and pressure to bond gold surfaces together. Another method is cold fusion material bonding, a process that fuses materials at room temperature through surface activation techniques. While these methods offer efficient electrical connections, they can introduce complexity into the hybrid chip integration process by adding additional fabrication steps such as wire bonding and conductive via formation.

Inductive microelectronic interconnections 140 can employ coils or inductors on both the optical chiplet 150 and the VLSI chip 110 for power and signal coupling between the chips. Inductive microelectronic interconnections 140 allow for wireless power transfer and data communication between the optical chiplet 150 and the VLSI chip 110. A benefit of inductive coupling is that it eliminates the need for physical connectors that align with and intimately contact each other, thereby simplifying the system integration process. However, inductive microelectronic interconnections are aligned and spaced to improve coupling efficiency. The design of inductive microelectronic interconnections 140 should also account for potential electromagnetic interference.

Acoustic microelectronic interconnections 140 provide another option for wireless communication between the optical chiplet 150 and VLSI chip 110. These microelectronic interconnections use high-frequency acoustic waves to transmit data and even power between the chiplet and chip. Such microelectronic interconnections are especially effective in high-frequency applications where electromagnetic coupling can be inefficient or problematic. Acoustic microelectronic interconnections can be implemented with piezoelectric materials or other electro-acoustic components to convert between electrical and acoustic signals.

### 6. Aspects of Optical Chiplets

The integration of optical transmitters and optical receivers with VLSI ICs is an important technical challenge for contemporary optical communication systems. Optical transmitters can include modulators formed from materials described above that are non-standard CMOS foundry materials. The optical receivers are more forgiving and can comprise semiconductor detectors made from materials like silicon or germanium, coupled to an amplifier to boost the weak electrical signal. The challenge in integrating optical transmitters, optical receivers, and VLSI ICs lies in scalability without sacrificing performance. Traditional methods involve complex electrical interconnects between transmitters and receivers and VLSI ICs that lead to inefficiencies, such as increased latency and energy consumption. Reducing these interconnects with the optical chiplet approach described herein can improve signal integrity and system performance.

The optical chiplet approach described herein enables a 2-D areal coverage of a VLSI chip with optical transmitters and optical receivers, for example. This 2-D areal coverage can overcome conventional geometry-constrained information bottlenecks. Conventional bottlenecks occur when trying to move all the information handled by a VLSI chip 110 through conductive contacts distributed around the periphery of the chip. Although the information handled by the VLSI chip scales in proportion to the area A of the chip, the physical access to that information through the chip's periphery scales only as A^{1/2} creating the bottleneck. Integrating optical chiplets 150 (which can provide RF interfaces) across the surface of the VLSI chip 110 allows greater access to the information handled by the chip and can reduce or eliminate the bottleneck.

As described above, the optical chiplet approach provides a way to utilize a wide variety of materials that are non-standard to CMOS processing. These materials can be integrated onto and communicatively coupled to the VLSI chip 110 after the chip has been fabricated using conventional, zero-change VLSI processes.

In some implementations, the electrical, inductive, and/or mechanical microelectronic interconnections 140 between the optical chiplet 150 and VLSI chip 110 can be standardized so that microelectronic interconnections 140 and sockets 170 can be fabricated using back-end processes in a zero-change VLSI foundry. Standardized microelectronic interconnections between the optical chiplet and the VLSI chip can simplify the design stage and create flexibility and interoperability in the testing and application stages. Further, structural features of sockets 170 can aid in alignment and placement of the optical chiplets 150 as described above in connection with FIG. 11A through FIG. 11C.

Optical transmitters can use nanophotonic resonators to reduce the area of the optical chiplets. The area of an optical chiplet can be no greater than 1 mm² in some cases, no greater than 0.02 mm² in some cases, and yet no greater than 0.001 mm² in some cases. As depicted in FIG. 10B, a nanophotonic resonator comprising a PhC cavity can be implemented on an optical chiplet measuring no more than 30 microns along the chip's largest peripheral edge. The nanophotonic resonators can be co-designed for resonant enhancement of signal interactions together with off-chip coupling structures, including resonator-integrated vertical optical couplers.

The integration approach using optical chiplets 150 makes it possible to add optical components to a nearly arbitrary range of electronic chips or PICs without the need to re-design these chips. This capability is important for a number of reasons listed below.
Cost: Redesigning an electronic chip or PIC can be very expensive, requiring new designs, testing, as well as manufacturing changes. The integration of optical chiplets 150 makes it possible to mount the optical chiplet(s) 150 onto an existing electronic chip or PIC to add desired functionality (e.g., data I/O, photonic integrated circuit-based filters with built-in SOAs and detectors, etc). In some cases, the optical chiplet 150 can be more readily redesigned at lower cost to adapt to the VLSI chip 110. The integration of optical chiplets 150 can utilize existing electronic packing infrastructure.
Time to Product: The integration of optical chiplets 150 can provide faster time to product, especially if the required optical functionality is achievable from a standardized library of optical chiplets 150. For example, fabrication of an integrated EO device 100 can comprise selection of the optical chiplet(s), validation of optical chiplet functionality (does the chiplet, or do the chiplets, meet the specifications), and placement of the optical chiplet(s) onto the target VLSI chip 110 or PIC. In some implementations, a combination of optical chiplets 150 can first be assembled with or without another chip such as a PIC to define the desired hybrid optical chip that could then be coupled to the VLSI chip 110.
Reconfigurability: In some implementations, optical chiplets can be swapped to change optical functionality, a simple example of which is a change in operating wavelengths.
Compatibility with Advanced Electronic Systems: Many electronic systems, such as high-voltage applications involving high-electron mobility transistors in gallium nitride or application involving high-frequency THz electronics, have such narrow application areas that designing a PIC process around that functionality can be prohibitively expensive or time-consuming. Integration of optical chiplets 150 with such electronic systems could be used to add optical functionality to these systems with minimal changes and cost.

Integrating optical chiplets 150 onto zero-change VLSI chips 110 as described herein can yield high-performance integrated EO devices 100. The inventors envision integrated EO devices 100 that provide optical modulation speeds well over 10 GHz and can operate on wavelengths from approximately or exactly 200 nm to approximately or exactly 2000 nm and possibly further into the infrared wavelengths. Modulation contrast can be over 25 dB with optical coupling losses on the order of 1 dB or less. The amount of energy used to modulate the phase of an optical wave by 180 degrees with some of the active optical devices 160 can be no greater than 1000 attojoules in some cases, and no greater than 100 attojoules in some cases. The amount of power needed to hold a transmission bit value can be no greater than 10 femtowatts in some cases and no greater than 2 femtowatts in some cases.

### 7. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within ±20% of a target (e.g., dimension or orientation) in some embodiments, within ±10% of a target in some embodiments, within ±5% of a target in some embodiments, and yet within ±2% of a target in some embodiments. The terms “approximately” and “about” can include the target. The term “essentially” is used to mean within ±3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An integrated electro-optical device comprising:
a very large scale integrated (VLSI) chip comprising a semiconductor substrate and a plurality of integrated circuit (IC) devices, the VLSI chip further comprising a microelectronic interconnection formed on a first side of the VLSI chip; and
an optical chiplet comprising an active optical device, wherein:
the optical chiplet is mounted to the VLSI chip such that the active optical device is adjacent to the first side of the VLSI chip, and
a control signal provided from the VLSI chip to the microelectronic interconnection, when the integrated electro-optical device is operating, couples to the active optical device and controls the active optical device on the optical chiplet.

2. The integrated electro-optical device of claim 1, wherein the active optical device is formed, at least in part, from lithium niobate.

3. The integrated electro-optical device of claim 1, wherein the active optical device comprises an optical resonator.

4. The integrated electro-optical device of claim 1, wherein the active optical device comprises an optical amplifier.

5. The integrated electro-optical device of claim 1, wherein the active optical device comprises an optical modulator.

6. The integrated electro-optical device of claim 1, wherein:
the active optical device comprises a ring resonator; and
the microelectronic interconnection comprises a radio-frequency (RF) oscillator, such that operation of the RF oscillator adjacent to the ring resonator:
produces optical RF combs from an optical wave propagating in the ring resonator; or
encodes data into an optical carrier wave propagating in the ring resonator.

7. The integrated electro-optical device of claim 6, wherein the RF oscillator is configured to be driven by an analog electrical signal as the control signal.

8. The integrated electro-optical device of claim 6, wherein the RF oscillator is configured to be driven by a digital electrical signal as the control signal.

9. The integrated electro-optical device of claim 1, wherein the active optical device comprises:
an optical resonator; and
a gain medium coupled to the optical resonator to provide an idler wave for difference-frequency generation with a modulated optical signal received in the optical resonator.

10. The integrated electro-optical device of claim 1, wherein the optical chiplet further comprises a microlens that optically couples to a photodetector formed on or in the VLSI chip.

11. The integrated electro-optical device of claim 1, wherein the microelectronic interconnection comprises at least one electrode to capacitively couple the control signal to the active optical device.

12. The integrated electro-optical device of claim 1, wherein the microelectronic interconnection comprises a pair of electrodes arranged to form an electric field that passes through at least a portion of the active optical device in response to the control signal to control a refractive index in the portion of the active optical device.

13. The integrated electro-optical device of claim 1, wherein the microelectronic interconnection comprises an inductor to create a magnetic field to couple the control signal to the active optical device to control the active optical device.

14. The integrated electro-optical device of claim 1, wherein the microelectronic interconnection comprises at least one ohmic contact to electrically couple the control signal to the active optical device to control the active optical device.

15. The integrated electro-optical device of claim 1, further comprising a grating coupler to couple light incident on the optical chiplet into an optical waveguide formed on or in the optical chiplet.

16. The integrated electro-optical device of claim 1, wherein the optical chiplet is mounted in a socket formed on the VLSI chip.

17. A method of controlling an active optical device that is formed in an integrated electro-optical device, the integrated electro-optical device comprising:
a very large scale integrated (VLSI) chip comprising a semiconductor substrate and a plurality of integrated circuit (IC) devices, the VLSI chip further comprising a microelectronic interconnection formed on a first side of the VLSI chip; and
an optical chiplet comprising the active optical device, wherein the optical chiplet is mounted to the VLSI chip such that the active optical device is adjacent to the first side of the VLSI chip, the method comprising:
providing a control signal from the VLSI chip to the microelectronic interconnection such that the control signal couples to and controls the active optical device on the optical chiplet.

18. The method of claim 17, wherein the active optical device comprises an optical resonator and providing the control signal modulates at least one of a phase or an amplitude of an optical wave coupled into the optical resonator.

19. The method of claim 17, wherein the active optical device comprises a semiconductor optical amplifier and providing the control signal increases a power of an optical wave traveling through the semiconductor optical amplifier.

20. A method of making an integrated electro-optical device, the method comprising:
aligning an active optical device, formed on an optical chiplet, with a microelectronic interconnection formed on a first side of a VLSI chip, the VLSI chip comprising a semiconductor substrate and a plurality of IC devices; and
mounting the optical chiplet to the first side of the VLSI chip such that:
the active optical device is adjacent to the microelectronic interconnection; and
a control signal provided from the VLSI chip to the microelectronic interconnection, when the integrated electro-optical device is operating, couples to the active optical device and controls the active optical device on the optical chiplet.
